(19) United States
(12) Patent Application Publication
(10) Pub. No.: US 2004/0216684 A1
(43) Pub. Date: Nov. 4, 2004

(54) Bird feeder with squirrel proof seed port

(76) Inventor: James Roberts Obenshain, Peebles, OH (US)

Correspondence Address: NEAL O. WILLMANN, 9521 MONTGOMERY ROAD, CINCINNATI, OH, 45242, US

(21) Appl. No.: 10/853,478

(22) Filed: May 25, 2004

Related U.S. Application Data
(63) Continuation-in-part of application No. 10/039,803, filed on Jan. 8, 2002, now abandoned.

(51) Int. Cl. A01K 61/02

(52) U.S. Cl. 119/57.9

(57) ABSTRACT

A squirrel proof bird feeder having a cylindrical reservoir for the containment of seeds and having at least one opening in the wall of the reservoir and one seed port for each opening, said seed port comprising: a platform having an opening congruent with the opening in the wall of the reservoir and a tunnel having a first opening defined by the opening in the platform and extending from the first opening through the opening in the reservoir, into the interior of the reservoir and terminating in a partially occluded second opening, effectively discriminates in favor of small birds, and especially against squirrels, by limiting access to seed within the reservoir.

### BACKGROUND OF THE INVENTION

This invention relates to bird feeders, and more specifically, it relates to a bird feeder that is specifically designed and constructed to be particularly resistant to the ravages of marauding squirrels. It is not uncommon for bird lovers to set out a supply of bird seed to attract and feed the avian residents of the neighborhood only to have most, if not all, of the seeds devoured by ravenous rodents, i.e., squirrels. The disclosed bird feeder has been demonstrated in field studies to present a formidable challenge to the most acrobatic and brazen of squirrels. Field tests have demonstrated that the bird feeder disclosed herein, with a seed port having a tunnel that burrows into the confines of the feeder, makes the seed in the feeder inaccessible, and therefore unavailable, to wildlife other than small wild birds.

### DESCRIPTION OF THE PRIOR ART

This is not the first bird feeder to address the need to frustrate squirrels in what appears to be their seemingly insatiable appetite for seeds at the backyard bird feeder. Patent references describing all manner of devices and contraptions for thwarting the uninvited dinner guests are legion. Many of the references describe bird feeders having baffles and spring-loaded perches. Some employ elaborate electrical configurations, and others utilize traps.

One reference, U.S. Pat. No. 5,479,878, which issued Jan. 2, 1996 to Coulter, has some relevance to the seed port disclosed herein in that it provides bird entry portals of various sizes to admit birds of certain sizes and prohibit access to birds, or other creatures, of larger sizes. All of the prior art devices appear to be effective, to some extent; however, there remains a need for an effective and simple design that is easy to manufacture and inexpensive to purchase, which will feed desirable birds and deter or discourage the feeding of large birds and squirrels.

### SUMMARY OF THE INVENTION

The present invention discloses a bird feeder that meets all of the criteria for an affordable, wild bird feeding device. Specifically, it is a bird seed feeder which comprises: a generally cylindrical seed reservoir having at least one opening in its wall for permitting access to its contents and at least one seed port for each opening, said seed port comprising: a platform attachable to the reservoir, said platform having an opening congruent with an opening in the wall of the reservoir; and, a tunnel having a first opening defined by the opening in said platform, said tunnel extending from said first opening, through the congruent wall opening, into the interior of the reservoir and terminating in a second opening, said second opening being partially occluded to limit access to seed within the reservoir.

### BRIEF DESCRIPTION OF THE DRAWING

FIG. 1 is an elevated side view of the disclosed bird feeder in partial section showing three seed ports in a front and two side views.

FIG. 2 is an elevated front view of the disclosed seed port.

FIG. 3 is an elevated rear view of the disclosed seed port.

FIG. 4 is an elevated side view of the disclosed seed port, both sides being identical.

FIG. 5 is a bottom plan view of the disclosed seed port.

And FIG. 6 is a top plan view of the disclosed seed port. And,

FIG. 7 is a perspective rear view of the disclosed seed port

### DESCRIPTION OF THE PREFERRED EMBODIMENT

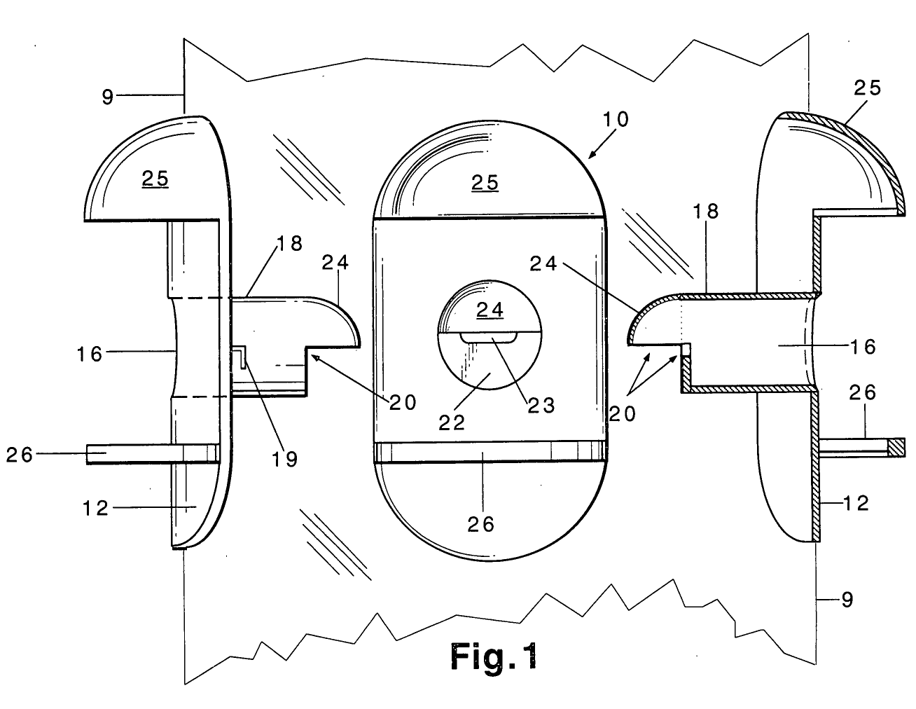

A comprehensive elaboration of the disclosed squirrel proof seed port begins by referring to the drawing. FIG. 1 depicts the squirrel proof seed port in its entirety by showing three seed ports 10 affixed in proximity to a bird seed reservoir 9 to better illustrate all aspects of the seed port. The platform 12 of the seed port 10 is preferably curved to conform to the generally cylindrical shape of the reservoir 9. In attaching the seed port to the reservoir, the seed port opening 16 is necessarily aligned with an opening (not shown) in the reservoir to permit access to the seed within the reservoir. The seed port 10 can be semi-permanently affixed to the reservoir 9 in any of several ways, but to facilitate removal and cleaning, it is preferably held in place by the use of tabs 19 that flex slightly to form a friction fit between the seed port 10 and the reservoir 9.

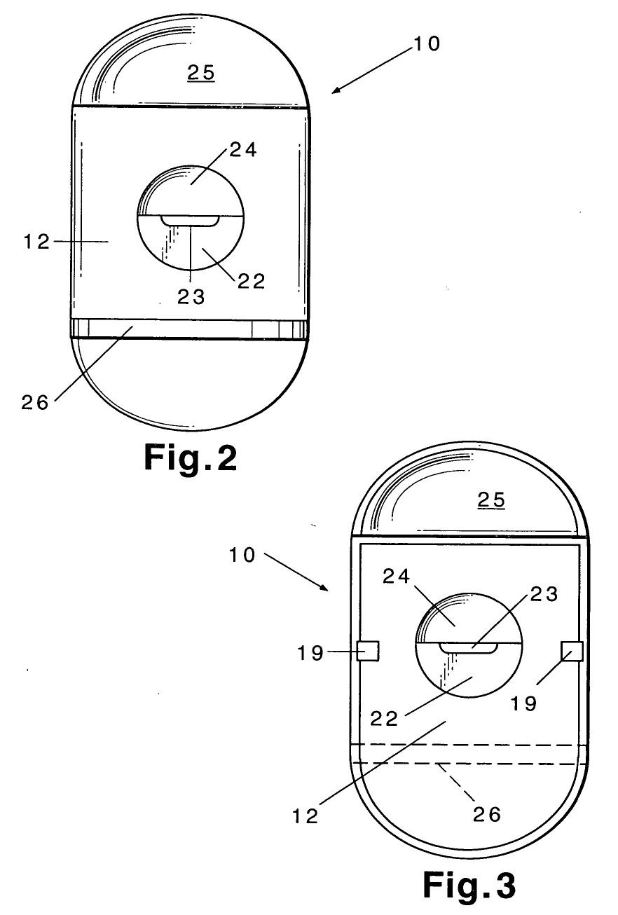

It is also apparent from FIG. 1 that the seed port opening 16 opens up and leads into tunnel 18, which extends into the interior of the reservoir 9 by passing through the opening in the reservoir 9, which, of necessity, is congruent with the seed port opening 16. The seed port tunnel 18 terminates in a second opening, within the reservoir, which is partially occluded. The occlusion of the second opening 20 is effected, in the preferred embodiment, by a seed dam 22 and cowl 24. FIGS. 2 and 3 present a clear view of dam 22. It is preferably semi-circular in design and shape to conform and fit within the curvature and profile of the tunnel 18. In a most preferred embodiment (FIG. 7), the dam 22 is right-angled and partially occludes the second opening 20 with horizontal 30 and vertical 31 components, forming a spill-way 23. The right-angled construction of the dam renders the second opening even more inaccessible to feeders other than birds. The tunnel could, of course, be configured in any of a variety of shapes, but a tunnel having a shape consistent with a circular seed port opening 16 is preferred. The seed dam 22 functions to curtail or restrict the free flow of seeds from the interior of the reservoir 9 into the tunnel 18 where they would ultimately flow freely through the seed port opening 16 and onto the ground to be wasted or inefficiently consumed.

The cowl 24 also functions to partially occlude the second opening 20 of the tunnel 18 and limit the free-flow of seed from the reservoir 9. The cowl 24 is preferably the semi-hemispherical extension and termination of the tunnel 18 formed by removing the lower-half or a 90° section of the distal end of the tunnel. The second opening in the tunnel, albeit partially occluded, provides seed flow opening 20. Thus, when properly positioned on the exterior surface of the reservoir, the squirrel proof seed port 10 provides a tunnel 18 to the stored seed, but, because of the partial occlusion, free flow of the seed is effectively limited by the cowl 24 and the seed dam 22, both of which will restrict, but not eliminate, the vertical and horizontal flow of seed into the tunnel 18.

However, to encourage a small amount of bird seed from the reservoir 9 to gravitate into the tunnel 18 and to be accessible to birds attempting to feed from the seed port 10, it is desirable to craft a small seed spill-way 23 into the upper edge of the dam 22.

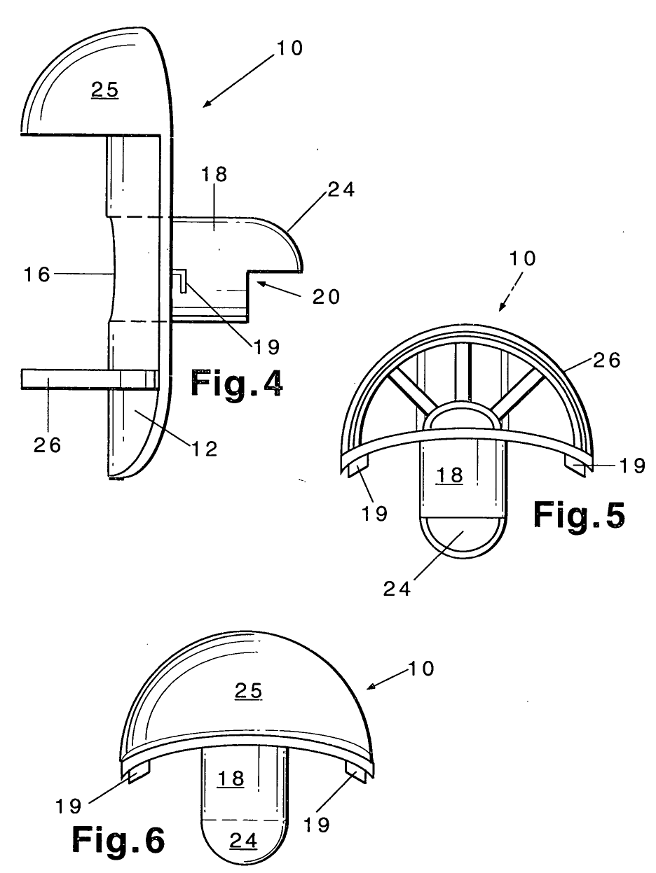

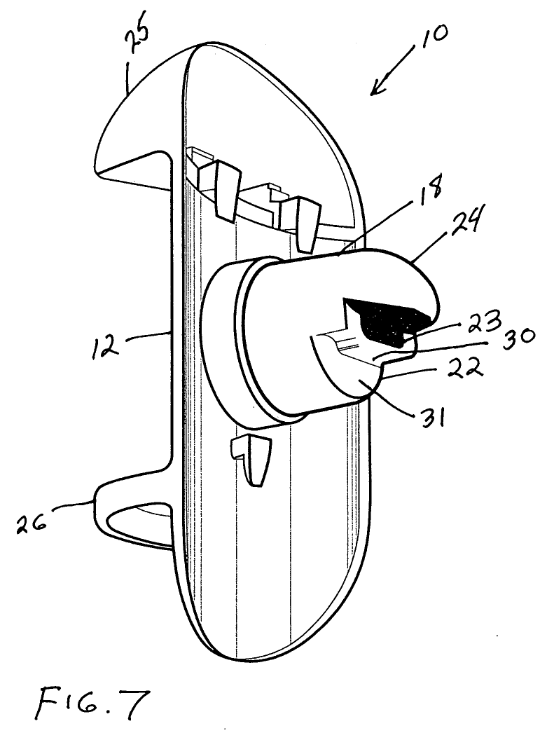

FIG. 4 depicts all essential and preferred elements of the seed port 10. Typically, a bird lights on the perch 26 and extends its head and upper body through the seed port opening 16, into the interior of the tunnel 18 and pecks at seeds that have flowed from the reservoir through seed flow opening 20 and which are on the threshold of the spillway 23 or have fallen over the seed spill-way onto the floor of the tunnel.

The effectiveness of the disclosed seed port has led all observers to conclude that the claustrophobic confines of the tunnel 18 and the relatively small amount of seed available near its second opening are sufficient to discourage feeders, other than small birds, from utilizing the benefits of the bird feeder.

Another amenity of the seed port 10, in addition to the perch 26, is the canopy 25, which, of course, is intended to shield and shade patrons of the seed port from the elements.

Construction of the disclosed bird feeder is intended to entail simple and inexpensive methods and materials. Typically, the reservoir will be fabricated from a clear plastic material to permit visual inspection of the contents thus enabling the owner to quickly determine when the feeder is in need of re-filling. The seed port is preferably forged from a metal material to maximize its durability and discourage enlargement of the tunnel by gnawing. Currently, because of the intricacies of the design, it is cast in one piece and attached to the reservoir and packaged for shipment and sale.

While the foregoing is a complete and detailed description of the preferred embodiment of the disclosed squirrel proof seed port, it should be apparent that numerous variations and modifications can be made and employed to implement the all-important purpose of the seed port without departing from the spirit of the invention, which is fairly defined by the appended claims.

I claim:

1. A bird seed feeder which comprises: a generally cylindrical seed reservoir having at least one opening in the wall of said reservoir and at least one seed port for each opening, said seed port comprising:
a platform attachable to the reservoir having an opening congruent with an opening in said reservoir wall; and,
a tunnel having continuously curving sides and a first opening defined by the opening in said platform and extending from said first opening, through the congruent wall opening in the reservoir, into the interior of the reservoir and terminating in a second opening, said second opening partially occluded to limit access to seed within the reservoir.

2. The bird feeder according to claim 1 wherein the seed port further includes a perch.

3. The bird feeder according to claim 1 wherein the seed port further includes a canopy.

4. The bird feeder according to claim 1 wherein the second opening of the seed port tunnel is partially occluded with a right-angled dam.
